(19) United States
(12) Patent Application Publication
(10) Pub. No.: US 2010/0154434 A1
(43) Pub. Date: Jun. 24, 2010

(54) Gas Turbine

(75) Inventors: Tetsuro Kubota, Takasago-shi (JP); Tatsuji Takahashi, Takasago-shi (JP); Keita Fujii, Takasago-shi (JP); Hiroto Katsura, Takasago-shi (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD.

(21) Appl. No.: 12/591,761

(22) Filed: Dec. 1, 2009

Related U.S. Application Data
(63) Continuation of application No. PCT/JP2008/073377, filed on Dec. 24, 2008.

(30) Foreign Application Priority Data
Aug. 6, 2008 (JP) 2008-203234

(51) Int. Cl. F02C 7/18

(52) U.S. Cl. 60/785

(57) ABSTRACT

Disclosed is a gas turbine enabling turn down operation, of which the system and the operation can be simplified, and also the production cost and the maintenance cost can be reduced. Specifically disclosed is a gas turbine comprising: a compressor section (2); a combustor section (3); a turbine section (4); a gas turbine casing which houses the compressor section (2), the combustor section (3), and the turbine section (4) therein; a stator cooling air system (5) for leading compressed air extracted from midstream of the compressor section (2) into stator vanes which constitute the turbine section (4); and an air bleeding system (6) for extracting compressed air from the exit of the compressor section (2) to the outside of the gas turbine casing, wherein midstream of the stator cooling air system (5) and midstream of the air bleeding system (6) are connected via a connecting path (12), and at midstream of this connecting path (12), there is a flow rate control part (13) connected.

### TECHNICAL FIELD

The present invention relates to a gas turbine, and more specifically relates to a gas turbine enabling turn down operation (operation at part load or operation at low load).

### BACKGROUND ART

A gas turbine disclosed in Patent Citation 1 is known as an example of a gas turbine enabling turn down operation.

Patent Citation 1:

Japanese Unexamined Patent Application, Publication No. 2007-182883

### DISCLOSURE OF INVENTION

When a gas turbine is operated at high load, the turbine inlet temperature (combustor exit temperature) of the gas turbine is kept high and thus the CO (carbon monoxide) emission from the gas turbine can be kept low. However, when a gas turbine is operated at low load or part load, the CO emission may increase as the turbine inlet temperature decreases. For this reason, the above-mentioned Patent Citation 1 discloses a method that can maintain high turbine inlet temperatures even at low loads.

However, in the gas turbine disclosed in the Patent Citation 1, it is necessary to additionally provide (newly provide) a piping, a booster pump, and the like for pushing air extracted from a working fluid path before entering the combustor, into a working fluid path residing at a downstream of the combustor exit. This leads to a problem of complicating the system and the operation of the gas turbine, and a problem of incrementing the production cost and the maintenance cost.

The present invention was made to address such a situation, with an object of providing a gas turbine enabling turn down operation, by which the system and the operation of the gas turbine can be simplified, and also the production cost and the maintenance cost can be reduced.

In order to achieve the abovementioned object, the present invention employs the following solutions.

The gas turbine according to a first aspect of the present invention is a gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from the combustor section; a gas turbine casing which houses the compressor section, the combustor section, and the turbine section therein; a stator cooling air system for leading compressed air that has been extracted from midstream of the compressor section, into stator vanes which constitute the turbine section; and an air bleeding system for extracting compressed air from the exit of the compressor section to the outside of the gas turbine casing, wherein midstream of the stator cooling air system and midstream of the air bleeding system are connected via a connecting path, and midstream of this connecting path is connected with a flow rate control part.

According to the gas turbine of the first aspect of the present invention, the turn down operation is enabled by using the already-existing stator cooling air system and air bleeding system. Therefore, the system and the operation of the gas turbine can be simplified, and also the production cost and the maintenance cost can be reduced.

Moreover, upon the turn down operation, the flow rate control part (for example, a control valve) is opened. As a result, the (high pressure) compressed air that has been extracted from the exit (rear stage) of the compressor section bypasses the combustor section and runs through the stator cooling air system and the stator vanes until it flows in the working fluid path of the turbine section. Therefore, the temperature of the exhaust gas can be lowered.

Furthermore, upon the turn down operation, the (high pressure) compressed air that has been extracted from the exit (rear stage) of the compressor section bypasses the combustor section and runs through the stator cooling air system and the air bleeding system until it flows in the turbine section. Therefore, upon the turn down operation, the temperature of the turbine section can be lowered while keeping the turbine inlet temperature high, because of which the service life of parts constituting the turbine section such as turbine blades (rotor blades and stator vanes) can be elongated.

The gas turbine is more preferable if a backflow prevention part is connected to the stator cooling air system at the upstream side of a merge point, where the downstream end of the connecting path is merging.

According to such a gas turbine, the compressed air led to the upstream side of the stator cooling air system via the connecting path and the flow rate control part (for example, a control valve) can be kept from flowing from the merge point toward the compressor section, by the backflow prevention part (for example, a check valve). Therefore, the backflow from the merge point to the compressor section can be reliably prevented.

The gas turbine according to a second aspect of the present invention is a gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from the combustor section; a first stator cooling air system for leading compressed air that has been extracted from a low-pressure stage of the compressor section, into low-pressure stage stator vanes which constitute the turbine section; and a second stator cooling air system for leading compressed air that has been extracted from a high-pressure stage of the compressor section, into high-pressure stage stator vanes which constitute the turbine section, wherein midstream of the first stator cooling air system and midstream of the second stator cooling air system are connected via a connecting path.

According to the gas turbine of the second aspect of the present invention, the turn down operation is enabled by using the already-existing stator cooling air system. Therefore, the system and the operation of the gas turbine can be simplified, and also the production cost and the maintenance cost can be reduced.

Moreover, upon the turn down operation, the (high pressure) compressed air that has been extracted from the high-pressure stage of the compressor section bypasses the combustor section and runs through the first stator cooling air system and the stator vanes (for example, fourth stage stator vanes) until it flows in the working fluid path of the turbine section. Therefore, the temperature of the exhaust gas can be lowered.

Furthermore, upon the turn down operation, the (high pressure) compressed air that has been extracted from the high-pressure stage of the compressor section bypasses the combustor section and runs through the first stator cooling air system and the stator vanes (for example, fourth stage stator vanes) until it flows in the turbine section. Therefore, upon the turn down operation, the temperature of the turbine section can be lowered while keeping the turbine inlet temperature high, because of which the service life of parts constituting the turbine section such as turbine blades (rotor blades and stator vanes) can be elongated.

The gas turbine is more preferable if a backflow prevention part is connected to the first stator cooling air system at the upstream side of a merge point, where the downstream end of the connecting path is merging.

According to such a gas turbine, the compressed air led to the midstream of the first stator cooling air system via the connecting path can be kept from flowing from the merge point toward the compressor section, by the backflow prevention part (for example, a check valve). Therefore, the backflow from the merge point to the compressor section can be reliably prevented.

The gas turbine according to a third aspect of the present invention is a gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from the combustor section; a first stator cooling air system for leading compressed air that has been extracted from a low-pressure stage of the compressor section, into low-pressure stage stator vanes which constitute the turbine section; a second stator cooling air system for leading compressed air that has been extracted from a medium-pressure stage of the compressor section, into medium-pressure stage stator vanes which constitute the turbine section; and a third stator cooling air system for leading compressed air that has been extracted from a high-pressure stage of the compressor section, into high-pressure stage stator vanes which constitute the turbine section, wherein midstream of the second stator cooling air system and midstream of the third stator cooling air system are connected via a connecting path.

According to the gas turbine of the third aspect of the present invention, the turn down operation is enabled by using the already-existing stator cooling air system. Therefore, the system and the operation of the gas turbine can be simplified, and also the production cost and the maintenance cost can be reduced.

Moreover, upon the turn down operation, the (high pressure) compressed air that has been extracted from the high-pressure stage of the compressor section bypasses the combustor section and runs through the second stator cooling air system and the stator vanes (for example, third stage stator vanes) until it flows in the working fluid path of the turbine section. Therefore, the temperature of the exhaust gas can be lowered.

Furthermore, upon the turn down operation, the (high pressure) compressed air that has been extracted from the high-pressure stage of the compressor section bypasses the combustor section and runs through the second stator cooling air system and the stator vanes (for example, third stage stator vanes) until it flows in the turbine section. Therefore, upon the turn down operation, the temperature of the turbine section can be lowered while keeping the turbine inlet temperature high, because of which the service life of parts constituting the turbine section such as turbine blades (rotor blades and stator vanes) can be elongated.

The gas turbine is more preferable if a backflow prevention part is connected to the second stator cooling air system at the upstream side of a merge point, where the downstream end of the connecting path is merging.

According to such a gas turbine, the compressed air led to the midstream of the second stator cooling air system via the connecting path can be kept from flowing from the merge point toward the compressor section, by the backflow prevention part (for example, a check valve). Therefore, the backflow from the merge point to the compressor section can be reliably prevented.

The gas turbine according to a fourth aspect of the present invention is a gas turbine comprising: a compressor section for compressing combustion air; a combustor section for injecting a fuel into high pressure air being sent from this compressor section, to effect combustion so, as to generate a high temperature combustion gas; a turbine section which is located at the downstream side of this combustor section, and is driven by the combustion gas coming out from the combustor section; a first stator cooling air system for leading compressed air that has been extracted from a low-pressure stage of the compressor section, into low-pressure stage stator vanes which constitute the turbine section; a second stator cooling air system for leading compressed air that has been extracted from a medium-pressure stage of the compressor section into medium-pressure stage stator vanes which constitute the turbine section; and a third stator cooling air system for leading compressed air that has been extracted from a high-pressure stage of the compressor section, into high-pressure stage stator vanes which constitute the turbine section, wherein midstream of the first stator cooling air system and midstream of the second stator cooling air system, or midstream of the third stator cooling air system, are connected via a connecting path.

According to the gas turbine of the fourth aspect of the present invention, the turn down operation is enabled by using the already-existing stator cooling air system. Therefore, the system and the operation of the gas turbine can be simplified, and also the production cost and the maintenance cost can be reduced.

Moreover, upon the turn down operation, the (high pressure or medium pressure) compressed air has been extracted from the high-pressure stage or the medium-pressure stage of the compressor section bypasses the combustor section and runs through the first stator cooling air system and the stator vanes (for example, fourth stage stator vanes) until it flows in the working fluid path of the turbine section. Therefore, the temperature of the exhaust gas can be lowered.

Furthermore, upon the turn down operation, the (high pressure or medium pressure) compressed air has been extracted from the high-pressure stage or the medium-pressure stage of the compressor section bypasses the combustor section and runs through the first stator cooling air system and the stator vanes (for example, fourth stage stator vanes) until it flows in the turbine section. Therefore, upon the turn down operation, the temperature of the turbine section can be lowered while keeping the turbine inlet temperature high, because of which the service life of parts constituting the turbine section such as turbine blades (rotor blades and stator vanes) can be elongated.

The gas turbine is more preferable if a backflow prevention part is connected to the first stator cooling air system at the upstream side of a merge point, where the downstream end of the connecting path is merging.

According to such a gas turbine, the compressed air led to the midstream of the first stator cooling air system via the connecting path can be kept from flowing from the merge point toward the compressor section, by the backflow prevention part (for example, a check valve). Therefore, the backflow from the merge point to the compressor section can be reliably prevented.

The gas turbine according to a fifth aspect of the present invention is a gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from the combustor section; and at least two stator cooling air systems for respectively leading at least two types of compressed air that have been extracted from at least two positions having different pressures of the compressor section, into respective stator vanes which constitute the turbine section, according to the pressure of the extracted compressed air, wherein at least two of the stator cooling air systems are connected via a connecting path.

According to the gas turbine of the fifth aspect of the present invention, the turn down operation is enabled by using the already-existing stator cooling air system. Therefore, the system and the operation of the gas turbine can be simplified, and also the production cost and the maintenance cost can be reduced.

Moreover, upon the turn down operation, the compressed air that has been extracted from the compressor section bypasses the combustor section and runs through the stator cooling air system(s) and the stator vanes (for example, fourth stage stator vanes) until it flows in the working fluid path of the turbine section. Therefore, the temperature of the exhaust gas can be lowered.

Furthermore, upon the turn down operation, the compressed air that has been extracted from the compressor section bypasses the combustor section and runs through the stator cooling air system(s) and the stator vanes (for example, fourth stage stator vanes) until it flows in the turbine section. Therefore, upon the turn down operation, the temperature of the turbine section can be lowered while keeping the turbine inlet temperature high, because of which the service life of parts constituting the turbine section such as turbine blades (rotor blades and stator vanes) can be elongated.

The gas turbine is more preferable if a backflow prevention part is connected to the stator cooling air system at the upstream side of a merge point, where the downstream end of the connecting path is merging.

According to such a gas turbine, the compressed air led to the midstream of the stator cooling air system via the connecting path can be kept from flowing from the merge point toward the compressor section, by the backflow prevention part (for example, a check valve). Therefore, the backflow from the merge point to the compressor section can be reliably prevented.

The gas turbine according to a sixth aspect of the present invention is a gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from the combustor section; and a rotor cooling air system for leading compressed air that has been extracted from the exit of the compressor section, into a rotor which constitutes the turbine section, wherein midstream of the rotor cooling air system is connected with a boost compressor, and a bypass system for bypassing the boost compressor is provided.

According to the gas turbine of the sixth aspect of the present invention, upon the turn down operation, the boost compressor is operated. As a result, the (high pressure) compressed air that has been extracted from the high-pressure stage of the compressor section bypasses the combustor section and runs through the rotor cooling air system and the rotor blades until it is forcibly (vigorously) led in the working fluid path of the turbine section. Therefore, the temperature of the exhaust gas can be lowered.

Moreover, upon the turn down operation, the (high pressure) compressed air that has been extracted from the exit (rear stage) of the compressor section bypasses the combustor section and runs through the rotor cooling air system until it flows in the turbine section. Therefore, upon the turn down operation, the temperature of the turbine section can be lowered while keeping the turbine inlet temperature high, because of which the service life of parts constituting the turbine section such as turbine blades (rotor blades and stator vanes) can be elongated.

The gas turbine enabling turn down operation of the present invention can offer effects of simplifying the system and the operation of the gas turbine, and reducing the production cost and the maintenance cost.

### BRIEF DESCRIPTION OF DRAWINGS

FIG. 1 is a system diagram of the gas turbine according to a first embodiment of the present invention.

FIG. 2 is a system diagram of the gas turbine according to a second embodiment of the present invention.

FIG. 3 is a system diagram of the gas turbine according to a third embodiment of the present invention.

FIG. 4 is a system diagram of the gas turbine according to a fourth embodiment of the present invention.

FIG. 5 is a system diagram of the gas turbine according to a fifth embodiment of the present invention.

FIG. 6 is a system diagram of the gas turbine according to a sixth embodiment of the present invention.

FIG. 7 is a system diagram of the gas turbine according to a seventh embodiment of the present invention.

FIG. 8 is a system diagram of the gas turbine according to an eighth embodiment of the present invention.

FIG. 9 is a system diagram of the gas turbine according to a ninth embodiment of the present invention.

FIG. 10 is a system diagram of the gas turbine according to a tenth embodiment of the present invention.

FIG. 11 is a system diagram of the gas turbine according to an eleventh embodiment of the present invention.

FIG. 12 is a system diagram of the gas turbine according to a twelfth embodiment of the present invention.

FIG. 13 is a system diagram of the gas turbine according to a thirteenth embodiment of the present invention.

FIG. 14 is a system diagram of the gas turbine according to a fourteenth embodiment of the present invention.

FIG. 15 is a system diagram of the gas turbine according to a fifteenth embodiment of the present invention.

FIG. 16 is a system diagram of the gas turbine according to a sixteenth embodiment of the present invention.

FIG. 17 is a system diagram of the gas turbine according to a seventeenth embodiment of the present invention.

FIG. 18 is a system diagram of the gas turbine according to an eighteenth embodiment of the present invention.

FIG. 19 is a system diagram of the gas turbine according to a nineteenth embodiment of the present invention.

FIG. 20 is a system diagram of the gas turbine according to a twentieth embodiment of the present invention.

FIG. 21 is a system diagram of the gas turbine according to a twenty first embodiment of the present invention.

### EXPLANATION OF REFERENCE

1: Gas turbine
2: Compressor section
3: Combustor section
4: Turbine section
5: Stator cooling air system
6: Rotor cooling air system (air bleeding system)
12: Connecting pipe (connecting path)
13: Second control valve (flow rate control part)
21: Gas turbine
22: Merge point
23: Check valve (backflow prevention part)
31: Gas turbine
41: Gas turbine
42: Merge point
51: Gas turbine
61: Gas turbine
71: Gas turbine
81: Gas turbine
91: Gas turbine
92: Stator cooling air system
93: Rotor cooling air system (air bleeding system)
96: Connecting pipe (connecting path)
97: Second control valve (flow rate control part)
101: Gas turbine
102: Merge point
103: Check valve (backflow prevention part)
111: Gas turbine
121: Gas turbine
122: Merge point
131: Gas turbine
132: First connecting pipe (connecting path)
133: Second control valve (flow rate control part)
134: Second connecting pipe (connecting path)
135: Third control valve (flow rate control part)
136: Merge point
141: Gas turbine
142: Check valve (backflow prevention part)
151: Gas turbine
152: First stator cooling air system
153: Second stator cooling air system
154: Third stator cooling air system
155: Rotor cooling air system
156: Connecting pipe (connecting path)
161: Gas turbine
162: Merge point
163: Check valve (backflow prevention part)
171: Gas turbine
181: Gas turbine
182: Merge point
191: Gas turbine
201: Gas turbine
202: Merge point
211: Gas turbine
212: Rotor cooling air system
214: Boost compressor
215: Bypass system

### BEST MODE FOR CARRYING OUT THE INVENTION

Hereunder is a description of the gas turbine according to a first embodiment of the present invention with reference to FIG. 1. FIG. 1 is a system diagram of the gas turbine according to this embodiment.

As shown in FIG. 1, the gas turbine 1 of this embodiment comprises: a compressor section 2 for compressing combustion air; a combustor section 3 for injecting a fuel into high pressure air being sent from this compressor section 2, to effect combustion so as to generate a high temperature combustion gas; a turbine section 4 which is located at the downstream side of this combustor section 3, and is driven by the combustion gas coming out from the combustor section 3; a gas turbine casing (not shown) which houses the compressor section 2, the combustor section 3, and the turbine section 4 therein; a stator cooling air system 5 for leading (medium pressure) compressed air that has been extracted from midstream (mid stage) of the compressor section 2, into stator vanes (for example, second stage stator vanes) which constitute the turbine section 3; and a rotor cooling air system (air bleeding system) 6 for extracting (high pressure) compressed air from the exit (rear stage) of the compressor section 2 to the outside of the gas turbine casing, and leading the air into a rotor (not shown) which constitutes the turbine section 4, as main components.

At midstream of the stator cooling air system 5, there is a first cooler 7 which cools down the compressed air passing therethrough connected. In addition, the stator cooling air system 5 is connected with a bypass system 8 which bypasses the first cooler 7 (that is to say, which connects between a part of the stator cooling air system 5 at the upstream side of the first cooler 7 and another part of the stator cooling air system 5 at the downstream side of the first cooler 7). Moreover, at midstream of this bypass system 8, there is a control valve 9 for adjusting the air flow rate of the bypass system 8 connected.

Meanwhile, at midstream of the rotor cooling air system 6, there is a second cooler 10 which cools down the compressed air passing therethrough connected. In addition, the rotor cooling air system 6 at the upstream side of the second cooler 10 and the stator cooling air system 5 at the upstream side of the branch point 11, where the upstream end of the bypass system 8 is branching, are connected by a connecting pipe (connecting path) 12. At midstream of this connecting pipe 12, there is a second control valve (flow rate control part) 13 connected, the opening degree of which can be adjusted by a controller (not shown).

Regarding the connecting pipe 12 for extracting (high pressure) compressed air from the exit of the compressor section 2 to the outside of the gas turbine casing, and connecting to the stator cooling air system 5, the upstream end of the connecting pipe 12 may be directly connected to the exit of the compressor section 2 for use as the air bleeding system.

According to the gas turbine 1 of this embodiment, the turn down operation is enabled by using the stator cooling air system 5 which is already existing therein (as an essential component). Therefore, the system and the operation of the gas turbine can be simplified, and also the production cost and the maintenance cost can be reduced.

In addition, if the already-existing rotor cooling air system 6 is used as the air bleeding system, the system and the operation of the gas turbine can be further simplified, and the production cost and the maintenance cost can be further reduced.

Moreover, upon the turn down operation, the second control valve 13 is opened. As a result, the (high pressure) compressed air that has been extracted from the exit (rear stage) of the compressor section 2 bypasses the combustor section 3 and runs through the stator cooling air system 5 and the stator vanes (not shown) until it flows in the working fluid path of the turbine section 4. Therefore, the temperature of the exhaust gas can be lowered.

Furthermore, upon the turn down operation, the (high pressure) compressed air that has been extracted from the exit (rear stage) of the compressor section 2 bypasses the combustor section 3 and runs through the stator cooling air system 5 until it flows in the turbine section 4. Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

During the normal operation (for example, operation at full load), the second control valve 13 is closed. As a result, the (high pressure) compressed air that has been extracted from the exit (rear stage) of the compressor section 2 runs through the rotor cooling air system 6 until it is all let in the turbine section 4.

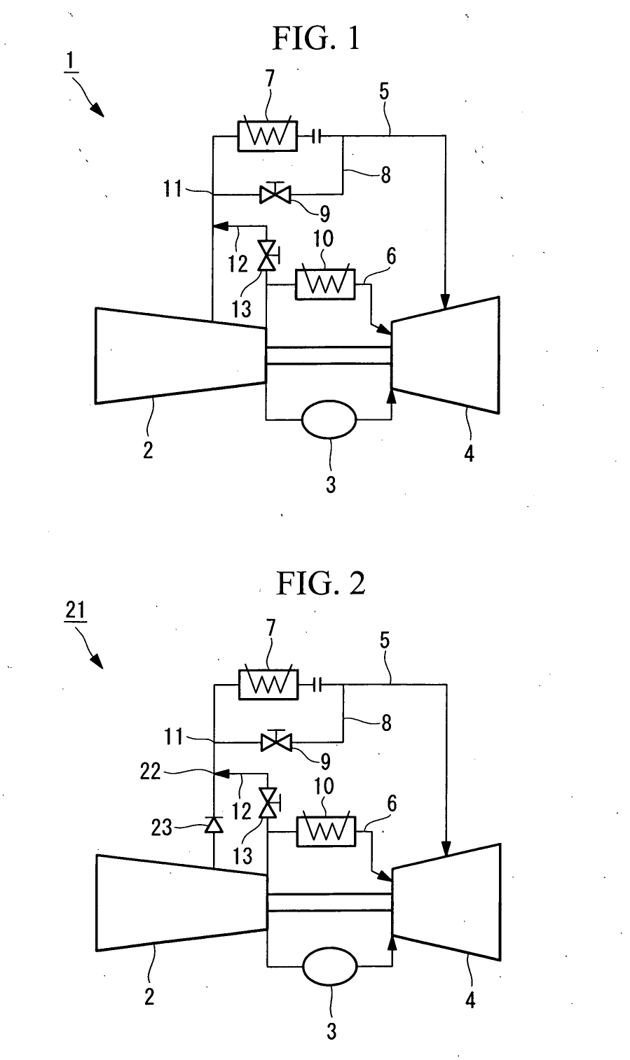

Here is a description of the gas turbine according to a second embodiment of the present invention with reference to FIG. 2. FIG. 2 is a system diagram of the gas turbine according to this embodiment.

As shown in FIG. 2, the gas turbine 21 of this embodiment differs from the gas turbine of the aforementioned first embodiment, in the point where a check valve (backflow prevention part) 23 is connected to the stator cooling air system 5 at the upstream side of a merge point 22, where the downstream end of the connecting pipe 12 is merging. The other components are the same as those of the aforementioned first embodiment, and thus these components are not described herein.

According to the gas turbine 21 of this embodiment, the compressed air led to the upstream side of the stator cooling air system 5 via the connecting pipe 12 and the second control valve 13 can be kept from flowing from the merge point 22 toward the compressor section 2, by the check valve 23. Therefore, the backflow from the merge point 22 to the compressor section 2 can be reliably prevented.

The other operations and effects are the same as those of the aforementioned first embodiment, and thus are not described herein.

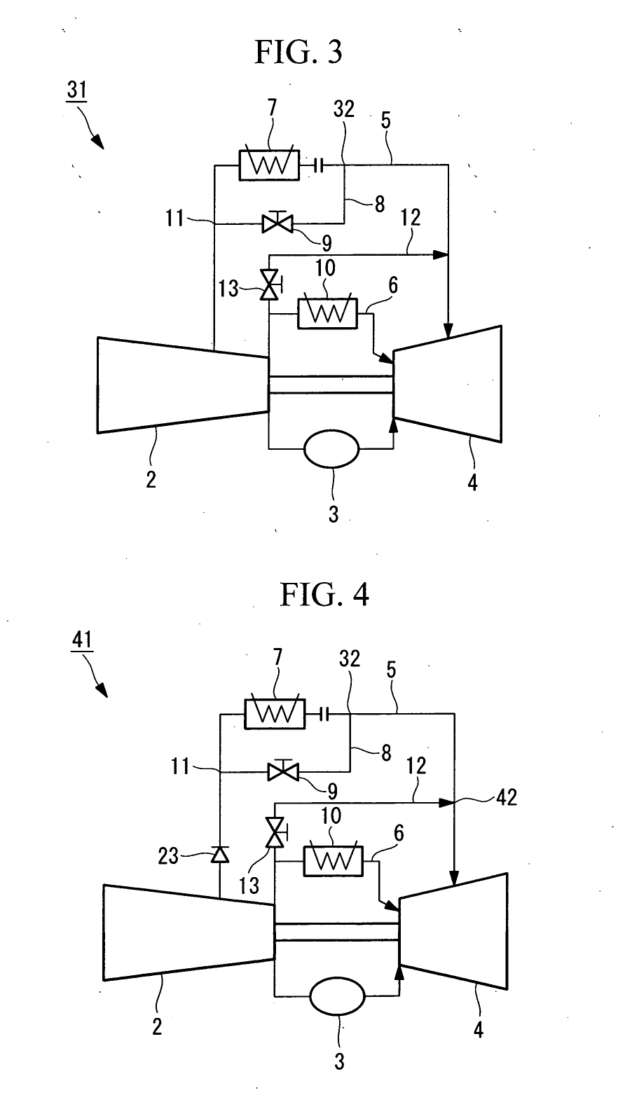

Here is a description of the gas turbine according to a third embodiment of the present invention with reference to FIG. 3. FIG. 3 is a system diagram of the gas turbine according to this embodiment.

As shown in FIG. 3, the gas turbine 31 of this embodiment differs from the gas turbine of the aforementioned first embodiment, in the point where the downstream end of the connecting pipe 12 is connected to the stator cooling air system 5 at the downstream side of a merge point 32, where the downstream end of the bypass system 8 is merging. The other components are the same as those of the aforementioned first embodiment, and thus these components are not described herein.

According to the gas turbine 31 of this embodiment, the turn down operation is enabled by using the stator cooling air system 5 which is already existing therein (as an essential component). Therefore, the system and the operation of the gas turbine can be simplified, and also the production cost and the maintenance cost can be reduced.

Moreover, upon the turn down operation, the second control valve 13 is opened. As a result, the (high pressure) compressed air that has been extracted from the exit (rear stage) of the compressor section 2 bypasses the combustor section 3 and runs through the stator cooling air system 5 and the stator vanes (not shown) until it flows in the working fluid path of the turbine section 4. Therefore, the temperature of the exhaust gas can be lowered.

Furthermore, upon the turn down operation, the (high pressure) compressed air that has been extracted from the exit (rear stage) of the compressor section 2 bypasses the combustor section 3 and runs through the stator cooling air system 5 until it flows in the turbine section 4. Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

During the normal operation (for example, operation at full load), the second control valve 13 is closed. As a result, the (high pressure) compressed air that has been extracted from the exit (rear stage) of the compressor section 2 runs through the rotor cooling air system 6 until it is all let in the turbine section 4.

Here is a description of the gas turbine according to a fourth embodiment of the present invention with reference to FIG. 4. FIG. 4 is a system diagram of the gas turbine according to this embodiment.

As shown in FIG. 4, the gas turbine 41 of this embodiment differs from the gas turbine of the aforementioned third embodiment, in the point where the check valve 23 is connected to the stator cooling air system 5 at the upstream side of the branch point 11, where the upstream end of the bypass system 8 is branching. The other components are the same as those of the aforementioned third embodiment, and thus these components are not described herein.

According to the gas turbine 41 of this embodiment, the compressed air led to the downstream side of the stator cooling air system 5 via the connecting pipe 12 and the second control valve 13 can be kept from flowing from a merge point 42, where the downstream end of the connecting pipe 12 is merging, toward the compressor section 2, by the check valve 23. Therefore, the backflow from the merge point 42 to the compressor section 2 can be reliably prevented.

The other operations and effects are the same as those of the aforementioned third embodiment, and thus are not described herein.

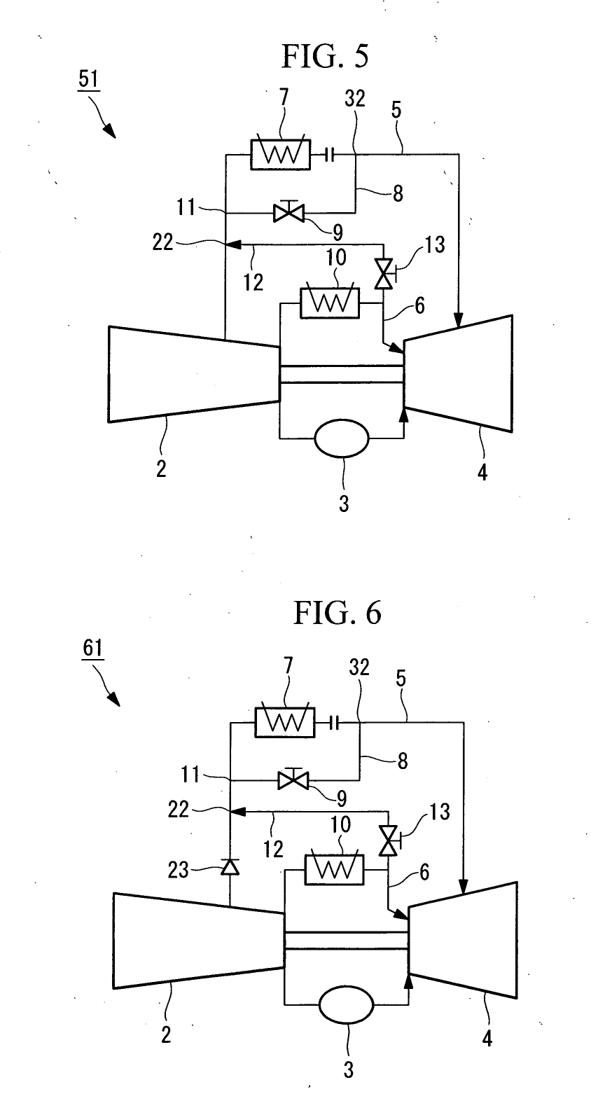

Here is a description of the gas turbine according to a fifth embodiment of the present invention with reference to FIG. 5. FIG. 5 is a system diagram of the gas turbine according to this embodiment.

As shown in FIG. 5, the gas turbine 51 of this embodiment differs from the gas turbine of the aforementioned first embodiment, in the point where the upstream end of the connecting pipe 12 is connected to the rotor cooling air system 6 at the downstream side of the second cooler 10. The other components are the same as those of the aforementioned first embodiment, and thus these components are not described herein.

According to the gas turbine 51 of this embodiment, the turn down operation is enabled by using the stator cooling air system 5 and the rotor cooling air system 6 which are already existing therein (as essential components). Therefore, the system and the operation of the gas turbine can be simplified, and also the production cost and the maintenance cost can be reduced.

Moreover, upon the turn down operation, the second control valve 13 is opened. As a result, the (high pressure) compressed air that has been extracted from the exit (rear stage) of the compressor section 2 bypasses the combustor section 3 and runs through the stator cooling air system 5 and the stator vanes (not shown) until it flows in the working fluid path of the turbine section 4. Therefore, the temperature of the exhaust gas can be lowered.

Furthermore, upon the turn down operation, the (high pressure) compressed air that has been extracted from the exit (rear stage) of the compressor section 2 bypasses the combustor section 3 and runs through the stator cooling air system 5 and the rotor cooling air system 6 until it flows in the turbine section 4. Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

During the normal operation (for example, operation at full load), the second control valve 13 is closed. As a result, the (high pressure) compressed air that has been extracted from the exit (rear stage) of the compressor section 2 runs through the rotor cooling air system 6 until it is all let in the turbine section 4.

Here is a description of the gas turbine according to a sixth embodiment of the present invention with reference to FIG. 6. FIG. 6 is a system diagram of the gas turbine according to this embodiment.

As shown in FIG. 6, the gas turbine 61 of this embodiment differs from the gas turbine of the aforementioned fifth embodiment, in the point where the check valve 23 is connected to the stator cooling air system 5 at the upstream side of the merge point 22, where the downstream end of the connecting pipe 12 is merging. The other components are the same as those of the aforementioned fifth embodiment, and thus these components are not described herein.

According to the gas turbine 51 of this embodiment, the compressed air led to the upstream side of the stator cooling air system 5 via the connecting pipe 12 and the second control valve 13 can be kept from flowing from the merge point 22 toward the compressor section 2, by the check valve 23. Therefore, the backflow from the merge point 22 to the compressor section 2 can be reliably prevented.

The other operations and effects are the same as those of the aforementioned fifth embodiment, and thus are not described herein.

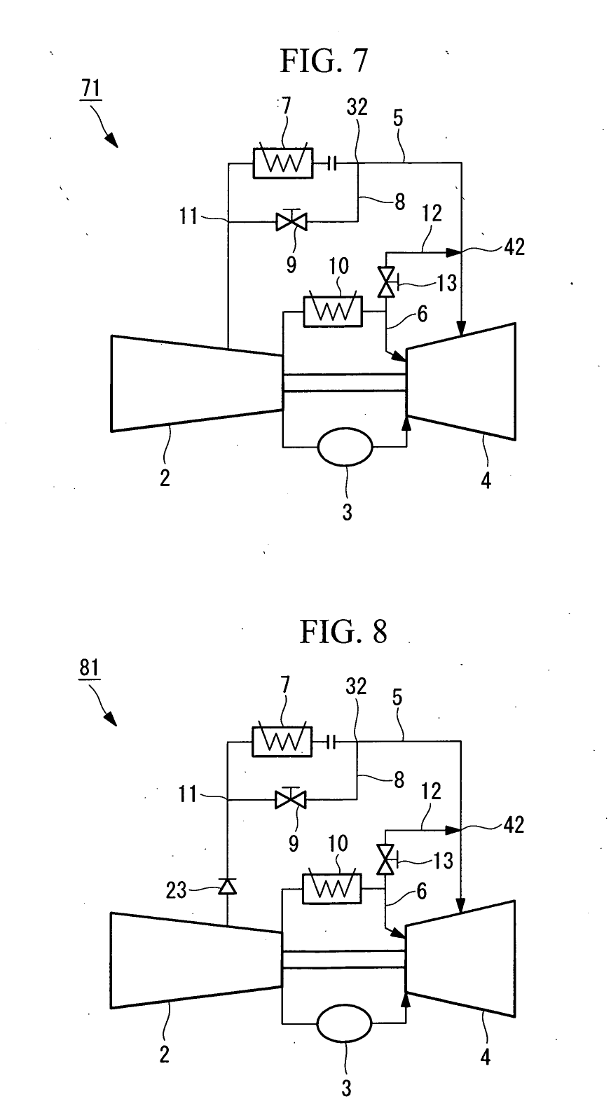

Here is a description of the gas turbine according to a seventh embodiment of the present invention with reference to FIG. 7. FIG. 7 is a system diagram of the gas turbine according to this embodiment.

As shown in FIG. 7, the gas turbine 71 of this embodiment differs from the gas turbine of the aforementioned fifth embodiment, in the point where the downstream end of the connecting pipe 12 is connected to the stator cooling air system 5 at the downstream side of the merge point 32, where the downstream end of the bypass system 8 is merging. The other components are the same as those of the aforementioned fifth embodiment, and thus these components are not described herein.

According to the gas turbine 71 of this embodiment, the turn down operation is enabled by using the stator cooling air system 5 and the rotor cooling air system 6 which are already existing therein (as essential components). Therefore, the system and the operation of the gas turbine can be simplified, and also the production cost and the maintenance cost can be reduced.

Moreover, upon the turn down operation, the second control valve 13 is opened. As a result, the (high pressure) compressed air that has been extracted from the exit (rear stage) of the compressor section 2 bypasses the combustor section 3 and runs through the stator cooling air system 5 and the stator vanes (not shown) until it flows in the working fluid path of the turbine section 4. Therefore, the temperature of the exhaust gas can be lowered.

Furthermore, upon the turn down operation, the (high pressure) compressed air that has been extracted from the exit (rear stage) of the compressor section 2 bypasses the combustor section 3 and runs through the stator cooling air system 5 and the rotor cooling air system 6 until it flows in the turbine section 4. Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

During the normal operation (for example, operation at full load), the second control valve 13 is closed. As a result, the (high pressure) compressed air that has been extracted from the exit (rear stage) of the compressor section 2 runs through the rotor cooling air system 6 until it is all let in the turbine section 4.

Here is a description of the gas turbine according to an eighth embodiment of the present invention with reference to FIG. 8. FIG. 8 is a system diagram of the gas turbine according to this embodiment.

As shown in FIG. 8, the gas turbine 81 of this embodiment differs from the gas turbine of the aforementioned seventh embodiment, in the point where the check valve (backflow prevention part) 23 is connected to the stator cooling air system 5 at the upstream side of the branch point 11, where the upstream end of the bypass system 8 is branching. The other components are the same as those of the aforementioned seventh embodiment, and thus these components are not described herein.

According to the gas turbine 81 of this embodiment, the compressed air led to the downstream side of the stator cooling air system 5 via the connecting pipe 12 and the second control valve 13 can be kept from flowing from the merge point 42, where the downstream end of the connecting pipe 12 is merging, toward the compressor section 2, by the check valve 23. Therefore, the backflow from the merge point 42 to the compressor section 2 can be reliably prevented.

The other operations and effects are the same as those of the aforementioned seventh embodiment, and thus are not described herein.

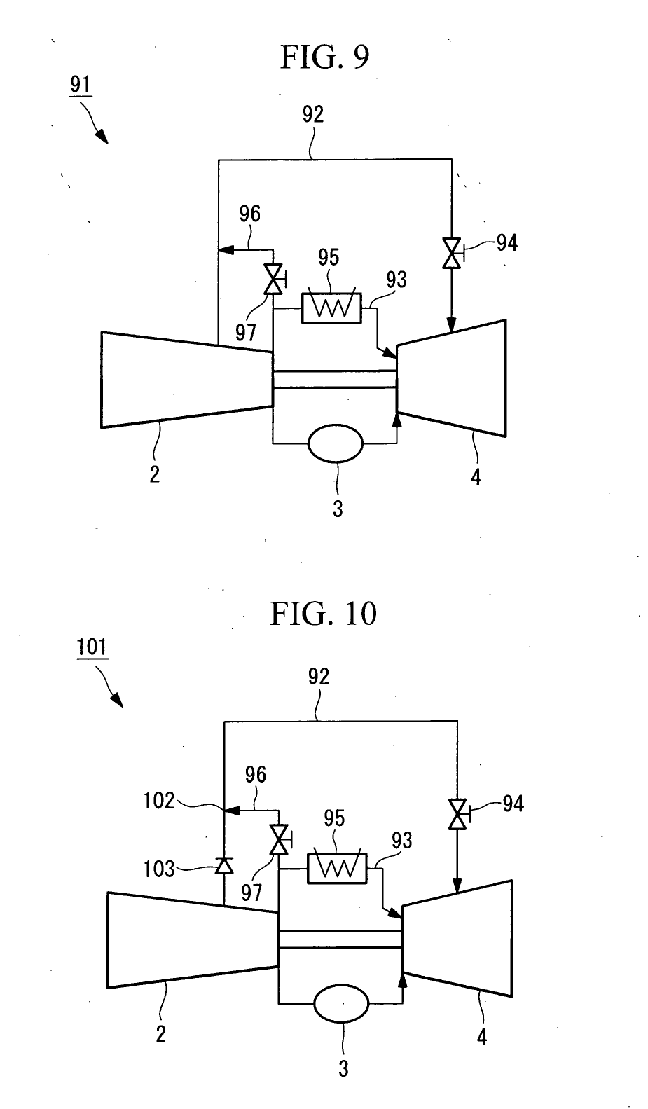

Here is a description of the gas turbine according to a ninth embodiment of the present invention with reference to FIG. 9. FIG. 9 is a system diagram of the gas turbine according to this embodiment.

As shown in FIG. 9, the gas turbine 91 of this embodiment comprises: a compressor section 2 for compressing combustion air; a combustor section 3 for injecting a fuel into high pressure air being sent from this compressor section 2, to effect combustion so as to generate a high temperature combustion gas; a turbine section 4 which is located at the downstream side of this combustor section 3, and is driven by the combustion gas coming out from the combustor section 3; a gas turbine casing (not shown) which houses the compressor section 2, the combustor section 3, and the turbine section 4 therein; a stator cooling air system 92 for leading (medium pressure) compressed air that has been extracted from midstream (mid stage) of the compressor section 2, into stator vanes (for example, second stage stator vanes) which constitute the turbine section 3; and a rotor cooling air system (air bleeding system) 93 for extracting (high pressure) compressed air from the exit (rear stage) of the compressor section 2 to the outside of the gas turbine casing, and leading the air into a rotor (not shown) which constitutes the turbine section 4, as main components.

At midstream of the stator cooling air system 92, there is a first control valve 94 connected, the opening degree of which can be adjusted by a controller (not shown).

Meanwhile, at midstream of the rotor cooling air system 93, there is a cooler 95 which cools down the compressed air passing therethrough connected. In addition, the rotor cooling air system 93 at the upstream side of the cooler 95 and the stator cooling air system 92 at the upstream side of the first control valve 94 are connected by a connecting pipe (connecting path) 96. At midstream of this connecting pipe 96, there is a second control valve (flow rate control part) 97 connected, the opening degree of which can be adjusted by a controller (not shown).

Regarding the connecting pipe 96 for extracting (high pressure) compressed air from the exit of the compressor section 2 to the outside of the gas turbine casing, and connecting to the stator cooling air system 92, the upstream end of the connecting pipe 96 may be directly connected to the exit of the compressor section 2 for use as the air bleeding system.

According to the gas turbine 91 of this embodiment, the turn down operation is enabled by using the stator cooling air system 92 which is already existing therein (as an essential component). Therefore, the system and the operation of the gas turbine can be simplified, and also the production cost and the maintenance cost can be reduced.

Moreover, upon the turn down operation, the second control valve 97 is opened. As a result, the (high pressure) compressed air that has been extracted from the exit (rear stage) of the compressor section 2 bypasses the combustor section 3 and runs through the stator cooling air system 92 and the stator vanes (not shown) until it flows in the working fluid path of the turbine section 4. Therefore, the temperature of the exhaust gas can be lowered.

Furthermore, upon the turn down operation, the (high pressure) compressed air that has been extracted from the exit (rear stage) of the compressor section 2 bypasses the combustor section 3 and runs through the stator cooling air system 92 and the rotor cooling air system 93 until it flows in the turbine section 4 Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

During the normal operation (for example, operation at full load), the second control valve 97 is closed. As a result, the (high pressure) compressed air that has been extracted from the exit (rear stage) of the compressor section 2 runs through the rotor cooling air system 93 until it is all let in the turbine section 4.

Here is a description of the gas turbine according to a tenth embodiment of the present invention with reference to FIG. 10. FIG. 10 is a system diagram of the gas turbine according to this embodiment.

As shown in FIG. 10, the gas turbine 101 of this embodiment differs from the gas turbine of the aforementioned ninth embodiment, in the point where a check valve (backflow prevention part) 103 is connected to the stator cooling air system 92 at the upstream side of a merge point 102, where the downstream end of the connecting pipe 96 is merging. The other components are the same as those of the aforementioned ninth embodiment, and thus these components are not described herein.

According to the gas turbine 101 of this embodiment, the compressed air led to the upstream side of the stator cooling air system 92 via the connecting pipe 96 and the second control valve 97 can be kept from flowing from the merge point 102 toward the compressor section 2, by the check valve 103. Therefore, the backflow from the merge point 102 to the compressor section 2 can be reliably prevented.

The other operations and effects are the same as those of the aforementioned ninth embodiment, and thus are not described herein.

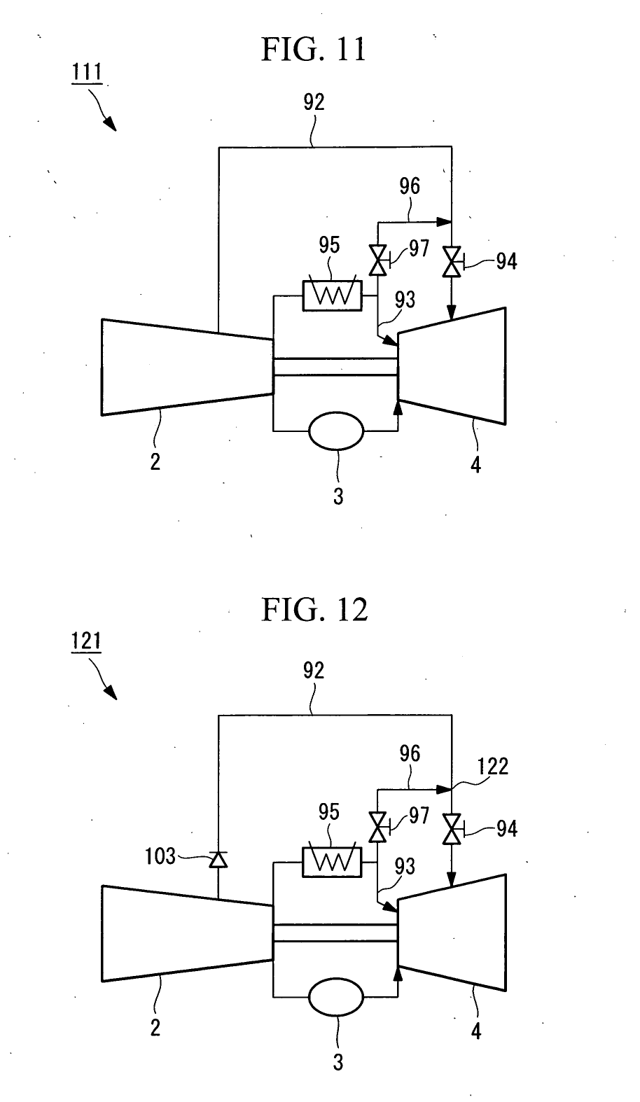

Here is a description of the gas turbine according to an eleventh embodiment of the present invention with reference to FIG. 11. FIG. 11 is a system diagram of the gas turbine according to this embodiment.

As shown in FIG. 11, the gas turbine 111 of this embodiment differs from the gas turbine of the aforementioned ninth embodiment, in the point where the upstream end of the connecting pipe 96 is connected to the rotor cooling air system 93 at the downstream side of the cooler 95, and the downstream end of the connecting pipe 96 is connected to the stator cooling air system 92 at the upstream side of the first control valve 94, and at the downstream side of the merge point 102 that is described in the tenth embodiment. The other components are the same as those of the aforementioned ninth embodiment, and thus these components are not described herein.

According to the gas turbine 111 of this embodiment, the turn down operation is enabled by using the stator cooling air system 92 and the rotor cooling air system 93 which are already existing therein (as essential components). Therefore, the system and the operation of the gas turbine can be simplified, and also the production cost and the maintenance cost can be reduced.

Moreover, upon the turn down operation, the second control valve 97 is opened. As a result, the (high pressure) compressed air that has been extracted from the exit (rear stage) of the compressor section 2 bypasses the combustor section 3 and runs through the stator cooling air system 92 and the stator vanes (not shown) until it flows in the working fluid path of the turbine section 4. Therefore, the temperature of the exhaust gas can be lowered.

Furthermore, upon the turn down operation, the (high pressure) compressed air that has been extracted from the exit (rear stage) of the compressor section 2 bypasses the combustor section 3 and runs through the stator cooling air system 92 and the rotor cooling air system 93 until it flows in the turbine section 4. Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

During the normal operation (for example, operation at full load), the second control valve 97 is closed. As a result, the (high pressure) compressed air that has been extracted from the exit (rear stage) of the compressor section 2 runs through the rotor cooling air system 93 until it is all let in the turbine section 4.

Here is a description of the gas turbine according to a twelfth embodiment of the present invention with reference to FIG. 12. FIG. 12 is a system diagram of the gas turbine according to this embodiment.

As shown in FIG. 12, the gas turbine 121 of this embodiment differs from the gas turbine of the aforementioned eleventh embodiment, in the point where the check valve 103 is connected to the stator cooling air system 92 at the upstream side of a merge point 122, where the downstream end of the connecting pipe 96 is merging. The other components are the same as those of the aforementioned eleventh embodiment, and thus these components are not described herein.

According to the gas turbine 121 of this embodiment, the compressed air led to the upstream side of the stator cooling air system 92 via the connecting pipe 96 and the second control valve 97 can be kept from flowing from the merge point 122 toward the compressor section 2, by the check valve 103. Therefore, the backflow from the merge point 122 to the compressor section 2 can be reliably prevented.

The other operations and effects are the same as those of the aforementioned eleventh embodiment, and thus are not described herein.

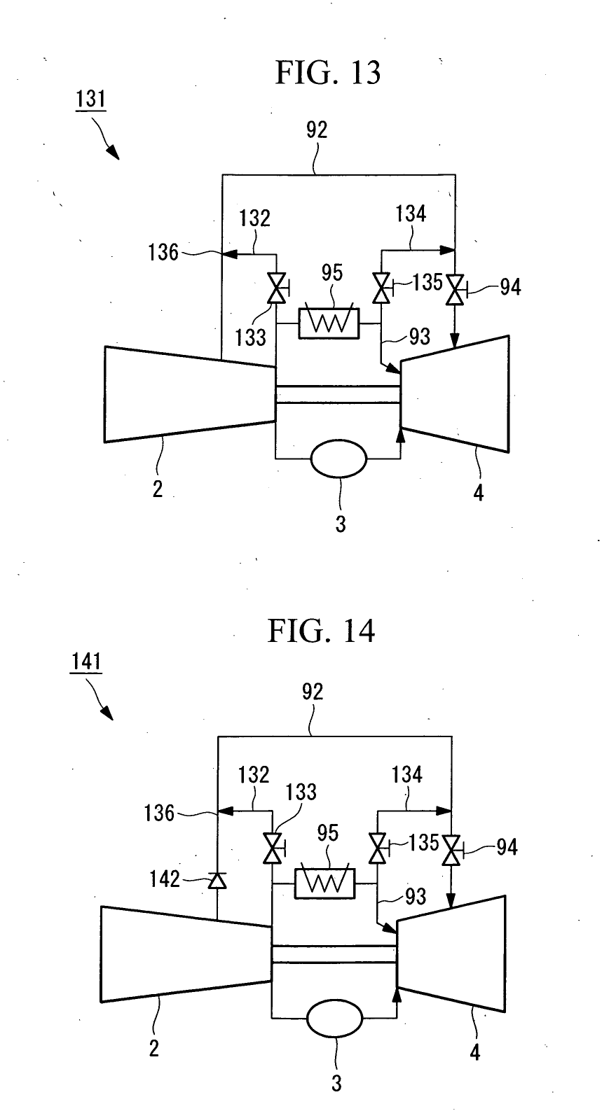

Here is a description of the gas turbine according to a thirteenth embodiment of the present invention with reference to FIG. 13. FIG. 13 is a system diagram of the gas turbine according to this embodiment.

As shown in FIG. 13, the gas turbine 131 of this embodiment differs from the gas turbine of the aforementioned ninth through twelfth embodiments, in the point where a first connecting pipe (connecting path) 132, a second control valve (flow rate control part) 133, a second connecting pipe (connecting path) 134, and a third control valve (flow rate control part) 135 are provided instead of the connecting pipe 96 and the second control valve 97. The other components are the same as those of the aforementioned ninth through twelfth embodiments, and thus these components are not described herein.

The rotor cooling air system 93 at the upstream side of the cooler 95 and the stator cooling air system 92 at the upstream side of the first control valve 94 are connected by the first connecting pipe 132. At midstream of this first connecting pipe 132, there is the second control valve 133 connected, the opening degree of which can be adjusted by a controller (not shown).

In addition, the rotor cooling air system 93 at the downstream side of the cooler 95 and the stator cooling air system 92 at the upstream side of the first control valve 94 and at the downstream side of a merge point 136, where the downstream end of the first connecting pipe 132 is merging, are connected by a second connecting pipe 134. At midstream of this second connecting pipe 134, there is the third control valve 135 connected, the opening degree of which can be adjusted by a controller (not shown).

According to the gas turbine 131 of this embodiment, the turn down operation is enabled by using the stator cooling air system 92 and the rotor cooling air system 93 which are already existing therein (as essential components). Therefore, the system and the operation of the gas turbine can be simplified, and also the production cost and the maintenance cost can be reduced.

Moreover, upon the turn down operation, the second control valve 133 and the third control valve 135 are opened. As a result, the (high pressure) compressed air that has been extracted from the exit (rear stage) of the compressor section 2 bypasses the combustor section 3 and runs through the stator cooling air system 92 and the stator vanes (not shown) until it flows in the working fluid path of the turbine section 4. Therefore, the temperature of the exhaust gas can be lowered.

Furthermore, upon the turn down operation, the (high pressure) compressed air that has been extracted from the exit (rear stage) of the compressor section 2 bypasses the combustor section 3 and runs through the stator cooling air system 92 and the rotor cooling air system 93 until it flows in the turbine section 4. Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

During the normal operation (for example, operation at full load), the second control valve 133 is closed. As a result, the (high pressure) compressed air that has been extracted from the exit (rear stage) of the compressor section 2 runs through the stator cooling air system 92 and the rotor cooling air system 93 until it is all let in the turbine section 4.

Here is a description of the gas turbine according to a fourteenth embodiment of the present invention with reference to FIG. 14. FIG. 14 is a system diagram of the gas turbine according to this embodiment.

As shown in FIG. 14, the gas turbine 141 of this embodiment differs from the gas turbine of the aforementioned thirteenth embodiment, in the point where a check valve (backflow prevention part) 142 is connected to the stator cooling air system 92 at the upstream side of the merge point 136. The other components are the same as those of the aforementioned thirteenth embodiment, and thus these components are not described herein.

According to the gas turbine 141 of this embodiment, the compressed air led to the upstream side of the stator cooling air system 92 via the first connecting pipe 132 and the second control valve 133, and/or the compressed air led to the upstream side of the stator cooling air system 92 via the second connecting pipe 134 and the third control valve 135, can be kept from flowing from the merge point 136 toward the compressor section 2, by the check valve 142. Therefore, the backflow from the merge point 136 to the compressor section 2 can be reliably prevented.

The other operations and effects are the same as those of the aforementioned thirteenth embodiment, and thus are not described herein.

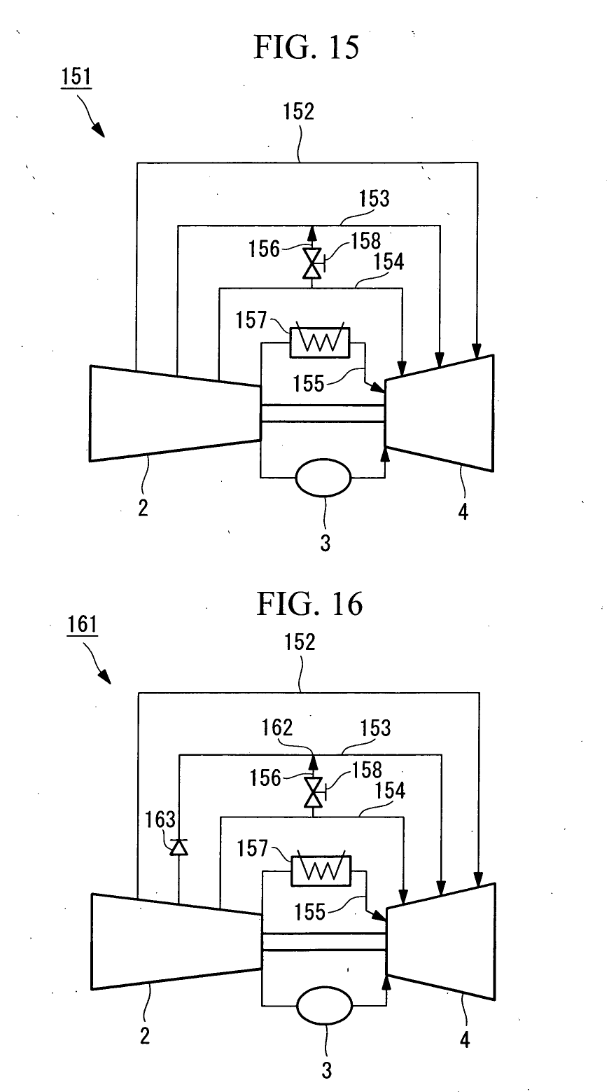

Here is a description of the gas turbine according to a fifteenth embodiment of the present invention with reference to FIG. 15. FIG. 15 is a system diagram of the gas turbine according to this embodiment.

As shown in FIG. 15, the gas turbine 151 of this embodiment comprises: a compressor section 2 for compressing combustion air; a combustor section 3 for injecting a fuel into high pressure air being sent from this compressor section 2, to effect combustion so as to generate a high temperature combustion gas; and a turbine section 4 which is located at the downstream side of this combustor section 3, and is driven by the combustion gas coming out from the combustor section 3, as main components.

In addition, the gas turbine 151 of this embodiment also comprises: a first stator cooling air system 152 for leading (low pressure) compressed air that has been extracted from a low-pressure stage of the compressor section 2, into stator vanes (for example, fourth stage stator vanes) which constitute the turbine section 3; a second stator cooling air system 153 for leading (medium pressure) compressed air that has been extracted from a medium-pressure stage of the compressor section 2, into stator vanes (for example, third stage stator vanes) which constitute the turbine section 3; a third stator cooling air system 154 for leading (high pressure) compressed air that has been extracted from a high-pressure stage of the compressor section 2, into stator vanes (for example, second stage stator vanes) which constitute the turbine section 3; and a rotor cooling air system 155 for leading compressed air that has been extracted from the exit of the compressor section 2 (having a higher pressure than the pressure of the compressed air extracted from the high-pressure stage of the compressor section 2), into a rotor (not shown) which constitutes the turbine section 4. Moreover, midstream of the second stator cooling air system 153 and midstream of the third stator cooling air system 154 are connected by the connecting pipe (connecting path) 156 so that a part of the compressed air passing through the third stator cooling air system 154 can be led to the second stator cooling air system 153 via the connecting pipe 156.

Meanwhile, at midstream of the rotor cooling air system 155, there is a cooler 157 which cools down the compressed air passing therethrough connected. At midstream of the connecting pipe 156, there is a control valve (flow rate control part) 158 connected, the opening degree of which can be adjusted by a controller (not shown).

According to the gas turbine 151 of this embodiment, the turn down operation is enabled by using the stator cooling air systems 152, 153, and 154 which are already existing therein (as essential components). Therefore, the system and the operation of the gas turbine can be simplified, and also the production cost and the maintenance cost can be reduced.

Moreover, upon the turn down operation, the control valve 158 is opened. As a result, the (high pressure) compressed air that has been extracted from the high-pressure stage of the compressor section 2 bypasses the combustor section 3 and runs through the second stator cooling air system 153 and the stator vanes (for example, third stage stator vanes) until it flows in the working fluid path of the turbine section 4. Therefore, the temperature of the exhaust gas can be lowered.

Furthermore, upon the turn down operation, the (high pressure) compressed air that has been extracted from the high-pressure stage of the compressor section 2 bypasses the combustor section 3 and runs through the second stator cooling air system 153 and the stator vanes (for example, third stage stator vanes) until it flows the turbine section 4. Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

During the normal operation (for example, operation at full load), the control valve 158 is closed. As a result, the (high pressure) compressed air that has been extracted from the high-pressure stage of the compressor section 2 runs through the third stator cooling air system 154 and the stator vanes (for example, second stage stator vane) until it is all let in the turbine section 4.

Here is a description of the gas turbine according to a sixteenth embodiment of the present invention with reference to FIG. 16. FIG. 16 is a system diagram of the gas turbine according to this embodiment.

As shown in FIG. 16, the gas turbine 161 of this embodiment differs from the gas turbine of the aforementioned fifteenth embodiment, in the point where a check valve (backflow prevention part) 163 is connected to the second stator cooling air system 153 at the upstream side of a merge point 162, where the downstream end of the connecting pipe 156 is merging. The other components are the same as those of the aforementioned fifteenth embodiment, and thus these components are not described herein.

According to the gas turbine 161 of this embodiment, the compressed air led to the midstream of the second stator cooling air system 153 via the connecting pipe 156 can be kept from flowing from the merge point 162 toward the compressor section 2, by the check valve 163. Therefore, the backflow from the merge point 162 to the compressor section 2 can be reliably prevented.

The other operations and effects are the same as those of the aforementioned fifteenth embodiment, and thus are not described herein.

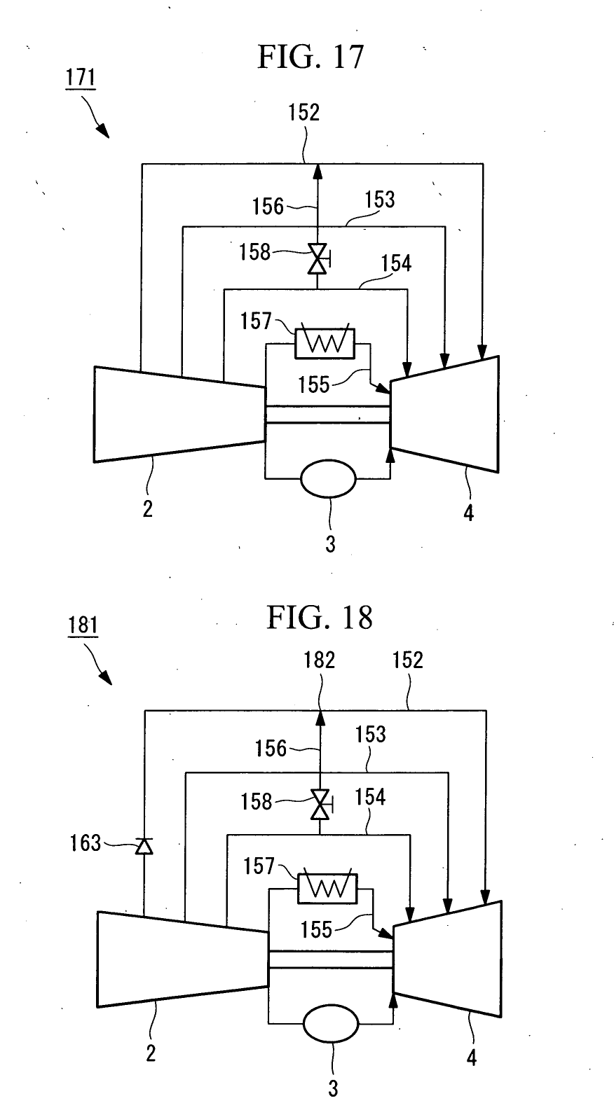

Here is a description of the gas turbine according to a seventeenth embodiment of the present invention with reference to FIG. 17. FIG. 17 is a system diagram of the gas turbine according to this embodiment.

As shown in FIG. 17, the gas turbine 171 of this embodiment differs from the gas turbine of the aforementioned fifteenth embodiment, in the point where the downstream end of the connecting pipe 156 is connected to midstream of the first stator cooling air system 152. The other components are the same as those of the aforementioned fifteenth embodiment, and thus these components are not described herein.

According to the gas turbine 171 of this embodiment, the turn down operation is enabled by using the stator cooling air systems 152, 153, and 154 which are already existing therein (as essential components). Therefore, the system and the operation of the gas turbine can be simplified, and also the production cost and the maintenance cost can be reduced.

Moreover, upon the turn down operation, the (high pressure) compressed air that has been extracted from the high-pressure stage of the compressor section 2 bypasses the combustor section 3 and runs through the first stator cooling air system 152 and the stator vanes (for example, fourth stage stator vanes) until it flows in the working fluid path of the turbine section 4. Therefore, the temperature of the exhaust gas can be lowered.

Furthermore, upon the turn down operation, the (high pressure) compressed air that has been extracted from the high-pressure stage of the compressor section 2 bypasses the combustor section 3 and runs through the first stator cooling air system 152 and the stator vanes (for example, fourth stage stator vanes) until it flows in the turbine section 4. Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

Here is a description of the gas turbine according to an eighteenth embodiment of the present invention with reference to FIG. 18. FIG. 18 is a system diagram of the gas turbine according to this embodiment.

As shown in FIG. 18, the gas turbine 181 of this embodiment differs from the gas turbine of the aforementioned seventeenth embodiment, in the point where the check valve 163 is connected to the first stator cooling air system 152 at the upstream side of a merge point 182, where the downstream end of the connecting pipe 156 is merging. The other components are the same as those of the aforementioned seventeenth embodiment, and thus these components are not described herein.

According to the gas turbine 171 of this embodiment, the compressed air led to the midstream of the first stator cooling air system 152 via the connecting pipe 156 can be kept from flowing from the merge point 182 toward the compressor section 2, by the check valve 163. Therefore, the backflow from the merge point 182 to the compressor section 2 can be reliably prevented.

The other operations and effects are the same as those of the aforementioned seventeenth embodiment, and thus are not described herein.

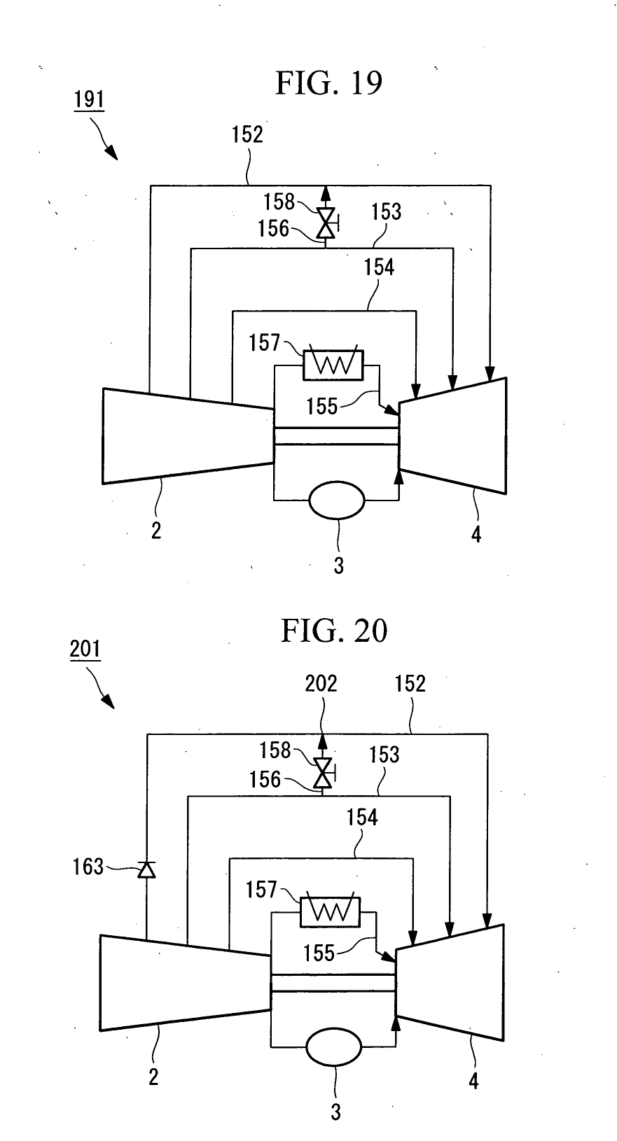

Here is a description of the gas turbine according to a nineteenth embodiment of the present invention with reference to FIG. 19. FIG. 19 is a system diagram of the gas turbine according to this embodiment.

As shown in FIG. 19, the gas turbine 191 of this embodiment differs from the gas turbine of the aforementioned seventeenth embodiment, in the point where the upstream end of the connecting pipe 156 is connected to midstream of the second stator cooling air system 153. The other components are the same as those of the aforementioned seventeenth embodiment, and thus these components are not described herein.

According to the gas turbine 191 of this embodiment, the turn down operation is enabled by using the stator cooling air systems 152, 153, and 154 which are already existing therein (as essential components). Therefore, the system and the operation of the gas turbine can be simplified, and also the production cost and the maintenance cost can be reduced.

Moreover, upon the turn down operation, the (medium pressure) compressed air that has been extracted from the medium-pressure stage of the compressor section 2 bypasses the combustor section 3 and runs through the first stator cooling air system 152 and the stator vanes (for example, fourth stage stator vanes) until it flows the working fluid path of the turbine section 4. Therefore, the temperature of the exhaust gas can be lowered.

Furthermore, upon the turn down operation, the (medium pressure) compressed air that has been extracted from the medium-pressure stage of the compressor section 2 bypasses the combustor section 3 and runs through the first stator cooling air system 152 and the stator vanes (for example, fourth stage stator vanes) until it flows in the turbine section 4. Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

Here is a description of the gas turbine according to a twentieth embodiment of the present invention with reference to FIG. 20. FIG. 20 is a system diagram of the gas turbine according to this embodiment.

As shown in FIG. 20, the gas turbine 201 of this embodiment differs from the gas turbine of the aforementioned nineteenth embodiment, in the point where the check valve 163 is connected to the first stator cooling air system 152 at the upstream side of the merge point 182, where the downstream end of the connecting pipe 156 is merging. The other components are the same as those of the aforementioned nineteenth embodiment, and thus these components are not described herein.

According to the gas turbine 201 of this embodiment, the compressed air led to the midstream of the first stator cooling air system 152 via the connecting pipe 156 can be kept from flowing from the merge point 202 toward the compressor section 2, by the check valve 163. Therefore, the backflow from the merge point 202 to the compressor section 2 can be reliably prevented.

The other operations and effects are the same as those of the aforementioned nineteenth embodiment, and thus are not described herein.

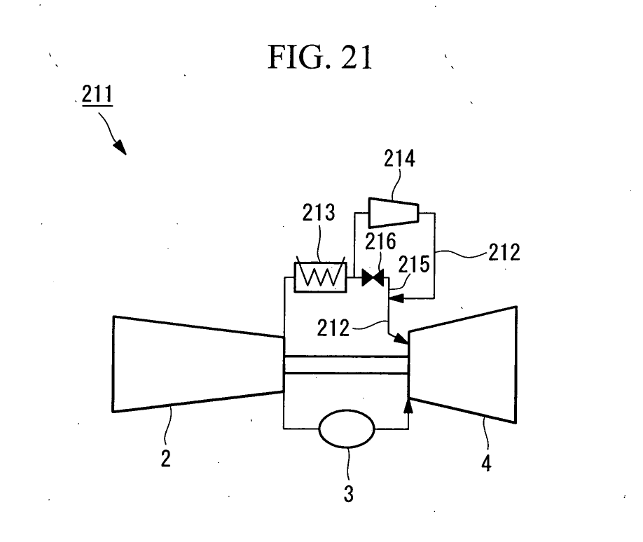

Here is a description of the gas turbine according to a twenty first embodiment of the present invention with reference to FIG. 21. FIG. 21 is a system diagram of the gas turbine according to this embodiment.

As shown in FIG. 21, the gas turbine 211 of this embodiment comprises: a compressor section 2 for compressing combustion air; a combustor section 3 for injecting a fuel into high pressure air being sent from this compressor section 2, to effect combustion so as to generate a high temperature combustion gas; a turbine section 4 which is located at the downstream side of this combustor section 3, and is driven by the combustion gas coming out from the combustor section 3; and a rotor cooling air system 212 for leading (high pressure) compressed air that has been extracted from the exit (rear stage) of the compressor section 2, into a rotor (not shown) which constitutes the turbine section 4, as main components.

At midstream of the rotor cooling air system 212, there is a cooler 213 which cools down the compressed air passing therethrough connected, and a boost compressor 214 which is turned on or off (started or shut down) by a controller (not shown). In addition, the rotor cooling air system 212 at the downstream side of the cooler 213 and at the upstream side of the boost compressor 214, and the rotor cooling air system 212 at the downstream side of the boost compressor 214 are connected by a bypass system 215. At midstream of this bypass system 215, there is a control valve 216 which is opened or closed by a controller (not shown) connected.

The control valve 216 is not an essential component.

According to the gas turbine 211 of this embodiment, upon the turn down operation, the control valve 216 is closed and the boost compressor 214 is operated. As a result, the (high pressure) compressed air that has been extracted from the high-pressure stage of the compressor section 2 bypasses the combustor section 3 and runs through the rotor cooling air system 212 and the rotor blades until it is forcibly (vigorously) led in the working fluid path of the turbine section 4. Therefore, the temperature of the exhaust gas can be lowered.

Moreover, upon the turn down operation, the (high pressure) compressed air that has been extracted from the exit (rear stage) of the compressor section 2 bypasses the combustor section 3 and runs through the rotor cooling air system 212 until it flows in the turbine section 4. Therefore, upon the turn down operation, the temperature of the turbine section 4 can be lowered while keeping the turbine inlet temperature high, because of which the service life of parts constituting the turbine section 4 such as turbine blades (rotor blades and stator vanes) can be elongated.

During the normal operation (for example, operation at full load), the-control valve 216 is opened and the boost compressor 214 is stopped. As a result, the (high pressure) compressed air that has been extracted from the exit (rear stage) of the compressor section 2 runs through the bypass system 215 until it flows in the turbine section 4.

In the abovementioned embodiments, the tubular connecting pipe is described as a specific example of the connecting path; however, the present invention is not to be limited to this. For example, the connecting path may be a block body having a continuous hole formed therein.

In addition, the “system” referred to in this description may be in any configuration such as a tubular piping and a block body having a continuous hole formed therein, as long as compressed air can pass therethrough.

Furthermore, in the aforementioned fifteenth through twentieth embodiments, the configuration comprising three stator cooling air systems is described; however, the present invention is not to be limited to this configuration, and may also comprise two, four, or even more stator cooling air systems.

1. A gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from said combustor section; a gas turbine casing which houses said compressor section, said combustor section, and said turbine section therein; a stator cooling air system for leading compressed air that has been extracted from midstream of said compressor section, into stator vanes which constitute said turbine section; and an air bleeding system for extracting compressed air from the exit of said compressor section to the outside of said gas turbine casing,
wherein midstream of said stator cooling air system and midstream of said air bleeding system are connected via a connecting path, and at midstream of this connecting path, there is a flow rate control part connected.

2. A gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from said combustor section; a first stator cooling air system for leading compressed air that has been extracted from a low-pressure stage of said compressor section, into low-pressure stage stator vanes which constitute said turbine section; and a second stator cooling air system for leading compressed air that has been extracted from a high-pressure stage of said compressor section, into high-pressure stage stator vanes which constitute said turbine section,
wherein midstream of said first stator cooling air system and midstream of said second stator cooling air system are connected via a connecting path.

3. A gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from said combustor section; a first stator cooling air system for leading compressed air that has been extracted from a low-pressure stage of said compressor section, into low-pressure stage stator vanes which constitute said turbine section; a second stator cooling air system for leading compressed air that has been extracted from a medium-pressure stage of said compressor section, into medium-pressure stage stator vanes which constitute said turbine section; and a third stator cooling air system for leading compressed air that has been extracted from a high-pressure stage of said compressor section, into high-pressure stage stator vanes which constitute said turbine section,
wherein midstream of said second stator cooling air system and midstream of said third stator cooling air system are connected via a connecting path.

4. A gas turbine according to claim 3, wherein a backflow prevention part is connected to said second stator cooling air system at the upstream side of a merge point, where the downstream end of said connecting path is merging.

5. A gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from said combustor section; a first stator cooling air system for leading compressed air that has been extracted from a low-pressure stage of said compressor section, into low-pressure stage stator vanes which constitute said turbine section; a second stator cooling air system for leading compressed air that has been extracted from a medium-pressure stage of said compressor section into medium-pressure stage stator vanes which constitute said turbine section; and a third stator cooling air system for leading compressed air that has been extracted from a high-pressure stage of said compressor section, into high-pressure stage stator vanes which constitute said turbine section,
wherein midstream of said first stator cooling air system and midstream of said second stator cooling air system, or midstream of said third stator cooling air system are connected via a connecting path.

6. A gas turbine according to claim 5, wherein a backflow prevention part is connected to said first stator cooling air system at the upstream side of a merge point, where the downstream end of said connecting path is merging.

7. A gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from said combustor section; and at least two stator cooling air systems for respectively leading at least two types of compressed air that have been extracted from at least two positions having different pressures of said compressor section, into respective stator vanes which constitute said turbine section, according to the pressure of the extracted compressed air,
wherein at least two of said stator cooling air systems are connected via a connecting path.

8. A gas turbine comprising: a compressor section for compressing combustion air; a combustor section for injecting a fuel into high pressure air being sent from this compressor section, to effect combustion so as to generate a high temperature combustion gas; a turbine section which is located at the downstream side of this combustor section, and is driven by the combustion gas coming out from said combustor section; and a rotor cooling air system for leading compressed air that has been extracted from the exit of said compressor section, into a rotor which constitutes said turbine section,
wherein at midstream of said rotor cooling air system, there is a boost compressor connected, and a bypass system for bypassing said boost compressor is provided.

9. A gas turbine according to claim 1, wherein a backflow prevention part is connected to said stator cooling air system at the upstream side of a merge point, where the downstream end of said connecting path is merging.

10. A gas turbine according to claim 2, wherein a backflow prevention part is connected to said first stator cooling air system at the upstream side of a merge point, where the downstream end of said connecting path is merging.

11. A gas turbine according to claim 7, wherein a backflow prevention part is connected to the stator cooling air system at the upstream side of a merge point, where the downstream end of said connecting path is merging.
